(19) United States
(12) Patent Application Publication
(10) Pub. No.: US 2024/0053827 A1
(43) Pub. Date: Feb. 15, 2024

(54) TOUCH FEEDBACK CORRECTION METHOD AND TOUCH MODULE USING SAME

(71) Applicant: Primax Electronics Ltd., Taipei (TW)

(72) Inventors: Chieh-Hung Hsieh, Taipei (TW); Wei-Chiang Huang, Taipei (TW); Chao-Wei Lee, Taipei (TW); Chun-Pi Wang, Taipei (TW); Hsueh-Chao Chang, Taipei (TW); Sian-Yi Chiu, Taipei (TW)

(21) Appl. No.: 17/899,682

(22) Filed: Aug. 31, 2022

(30) Foreign Application Priority Data
Aug. 9, 2022 (TW) 111129942

(51) Int. Cl. G06F 3/01; G06F 3/041

(52) U.S. Cl. CPC G06F 3/016; G06F 3/0418

(57) ABSTRACT

A touch feedback correction method and a touch module using the touch feedback correction method are provided. In the touch feedback correction method, the coordinate values and the initial vibration values of plural press region on a touch panel of the touch module are detected. Consequently, a driving voltage calibration table is established. Then, a vibrating unit of the touch module is driven according to plural compensated voltage values of the driving voltage calibration table. Consequently, the plural press regions generate plural corrected vibration values, respectively.

### FIELD OF THE INVENTION

The present invention relates to a correction method, and more particularly to a correction method for an input module.

### BACKGROUND OF THE INVENTION

A touch module is an input module of an electronic device. When a user's finger is pressed and slid on the touch module, the operations of the electronic device can be correspondingly controlled. Since the touch module is very thin and light, the touch module is widely used in a notebook computer, a mobile phone, a PDA or any other appropriate electronic device. As the trends of designing the modern electronic products are toward light weightiness and slimness, the applications of touch modules on the electronic products become more popular.

According to the operating principles of the touch module, a sensing unit is disposed within the touch module to sense the touched position, the touched number or the sliding trajectory of the user's hand and generate corresponding sensing values and control signals. Moreover, the touch module is usually equipped with a vibrating unit. When the touch module is pressed by the user, the vibrating unit is subjected to vibration. Consequently, a touch panel of the touch module generates vibration feedback.

However, since the dimensions or the stacking structures of touch panels of different input devices are usually different and the positions of the vibrating units are also different, some drawbacks occur. For example, when different press regions of the touch panel are pressed by the user, the press regions generate different vibration values. In other words, the user cannot achieve a good pressing experience

For solving the above drawbacks, it is important to provide a touch feedback correction method for generating the similar vibration feel on different press regions of a touch panel of a touch module.

### SUMMARY OF THE INVENTION

The present invention provides a touch feedback correction method for correcting the vibration values of a touch module. When different press regions on a touch panel of the touch module are pressed by the user, the touch panel can generate the similar vibration feedback.

In accordance with an aspect of the present invention, a touch feedback correction method for a touch module is provided. The touch module includes a touch panel, a vibrating unit and a storage unit. The vibrating unit is located under the touch panel to vibrate the touch panel. The storage unit being electrically connected with the vibrating unit. The touch feedback correction method includes the following steps. In a step (a), the touch panel are divided into plural press regions, and initial vibration values of the plural press regions are detected. In a step (b), a driving voltage calibration table is established according to coordinate values of the plural press regions and the initial vibration values of the plural press regions. The driving voltage calibration table contains plural compensated voltage values corresponding to the plural press regions. In a step (c), the driving voltage calibration table is written into a firmware of the storage unit. In a step (d), the firmware is executed to drive the vibrating unit according to the driving voltage calibration table. Consequently, the plural press regions generate plural corrected vibration values, respectively.

Preferably, in the step (a), a specified press region of the plural press regions is located over the vibrating unit. When a standard voltage value is provided to drive the vibrating unit, the initial vibration value corresponding to the specified press region is served as a standard vibration value.

Preferably, in the step (b), each of the plural compensated voltage values corresponding to the plural press regions is acquired through a calculation process.

Preferably, in the calculation process, each of the plural compensated voltage values is obtained according to a mathematic formula: Vc=Vs×(Gs/G1), wherein Vc is the compensated voltage value, Vs is the standard voltage value, Gs is the standard vibration value, and G1 is the corresponding initial vibration value.

In an embodiment, the touch feedback correction method further includes a step (e) of detecting the plural corrected vibration values of the plural press regions.

In an embodiment, the storage unit is a flash memory, an electrically-erasable programmable read-only memory (EEPROM) or a programmable read-only memory (PROM).

In accordance with another aspect of the present invention, a touch module is provided. The touch module includes a frame, a touch panel, a vibrating unit and a storage unit. The touch panel is installed on the frame. The touch panel includes plural press regions. The vibrating unit is located under the touch panel. The storage unit is electrically connected with the vibrating unit. A firmware of the storage unit contains a driving voltage calibration table. The driving voltage calibration table contains plural compensated voltage values corresponding to the plural press regions. The firmware is executed to drive the vibrating unit according to the plural compensated voltage values of the driving voltage calibration table. Consequently, the plural press regions generate plural corrected vibration values, respectively.

In an embodiment, each of the plural compensated voltage values corresponding to the plural press regions is acquired through a calculation process. In the calculation process, each of the plural compensated voltage values is obtained according to a mathematic formula: Vc=Vs×(Gs/G1), wherein Vc is the compensated voltage value, Vs is a standard voltage value, Gs is a standard vibration value, and G1 is the corresponding initial vibration value.

In an embodiment, when the standard voltage value is provided to drive the vibrating unit, the initial vibration value corresponding to the press region overlying the vibrating unit is served as the standard vibration value.

In an embodiment, the storage unit is a flash memory, an electrically-erasable programmable read-only memory (EEPROM) or a programmable read-only memory (PROM).

From the above descriptions, the present invention provides the touch feedback correction method. By the touch feedback correction method, the initial vibration values of the plural press regions on the touch panel of the control module can be corrected. After the correction, the corrected vibration values of the plural press regions on the touch panel are equal or nearly equal. Consequently, the uniformity and consistency of the vibration feels corresponding to different press region will be enhanced. When different press regions of the touch panel are pressed, the touch panel can generate the similar vibration feedback.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A is a schematic functional block diagram illustrating the architecture of a touch feedback correction system according to an embodiment of the present invention;

FIG. 1B is a schematic top view illustrating the touch module of the touch feedback correction system according to the embodiment of the present invention;

FIG. 2 is a flowchart illustrating a touch feedback correction method according to an embodiment of the present invention; and

FIG. 3 is a line graph illustrating the vibration values of the press regions of the touch module of the present invention before and after correction.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

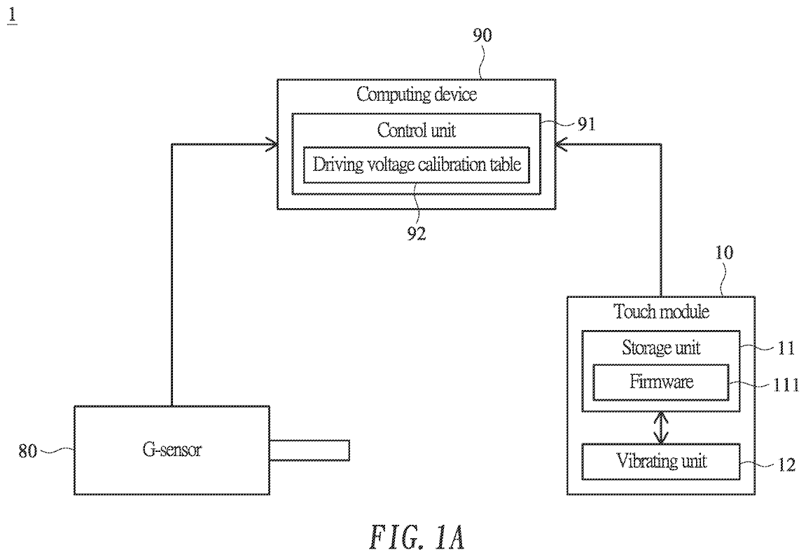

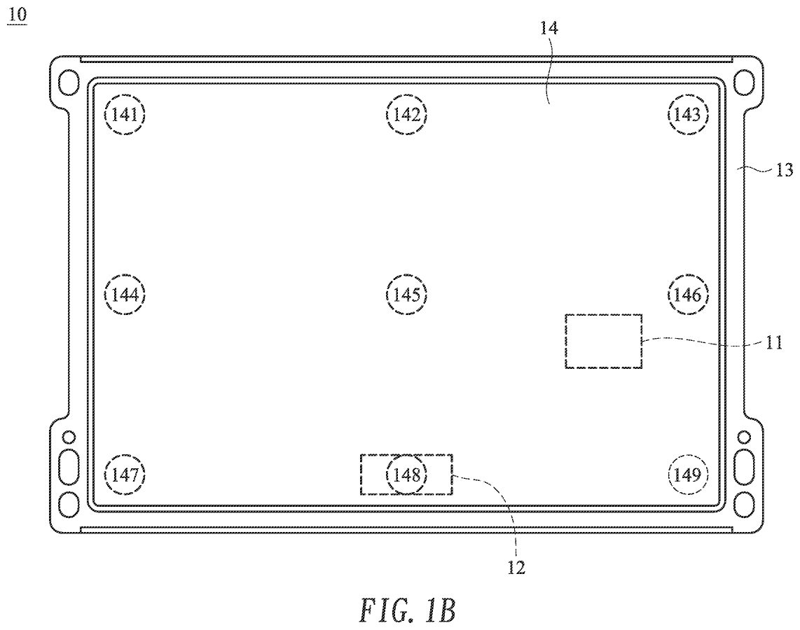

FIG. 1A is a schematic functional block diagram illustrating the architecture of a touch feedback correction system according to an embodiment of the present invention. As shown in FIG. 1A, the touch feedback correction system 1 comprises a touch module 10, a G-sensor 80 and a computing device 90. The computing device 90 comprises a control unit 91. The computing device 90 is electrically connected with the touch module 10 and the G-sensor 80. The G-sensor 80 is used for detecting the vibration value of the touch module 10 when the touch module 10 is subjected to vibration.

The touch module 10 comprises a storage unit 11 and a vibrating unit 12. The storage unit 11 comprises a firmware 111. Moreover, the storage unit 11 is electrically connected with the vibrating unit 12. The execution of the firmware 111 can control the operations of the touch module 10. Moreover, the execution of the firmware 111 can drive the vibrating unit 12 to result in vibration of the touch module 10. Preferably but not exclusively, the storage unit 11 is a flash memory, an electrically-erasable programmable read-only memory (EEPROM) or a programmable read-only memory (PROM).

Please refer to FIG. 1A again. After the vibration values at different press regions of the touch module 10 are detected by the G-sensor 80, the values of the vibration values are transmitted to the computing device 90. At the same time, the coordinate values of the press regions detected by the G-sensor 80 are transmitted from the touch module 10 to the computing device 90. According to the values of the vibration values of the press regions and the coordinate values of the press regions, the control unit 91 of the computing device 9 establishes a driving voltage calibration table 92.

FIG. 1B is a schematic top view illustrating the touch module of the touch feedback correction system according to the embodiment of the present invention. As shown in FIG. 1B, the touch module 10 comprises the storage unit 11, the vibrating unit 12, a frame 13 and a touch panel 14. The touch panel 14 is installed on the frame 13. The vibrating unit 12 is located under the touch panel 14. The storage unit 11 is also located under the touch panel 14. Moreover, the storage unit 11 is electrically connected with the vibrating unit 12.

In an embodiment, the touch panel 14 is equally divided into nine press regions 141˜449 in a nine-square grid form. The vibrating unit 12 is located under the press region 148. When the user's finger is placed on the touch panel 14 to touch or press the touch panel 14, the touch module 10 recognizes which of the press regions 141˜149 is touched or pressed according to the resolution of the touch panel 14 and the coordinate value of the position corresponding to the detected finger. In this embodiment, the touch panel 14 is divided into nine press regions in an array arrangement. It is noted that the number of the press regions and the arrangement of the press regions are not restricted. That is, the number of the press regions and the arrangement of the press regions may be varied according to the use or production requirements.

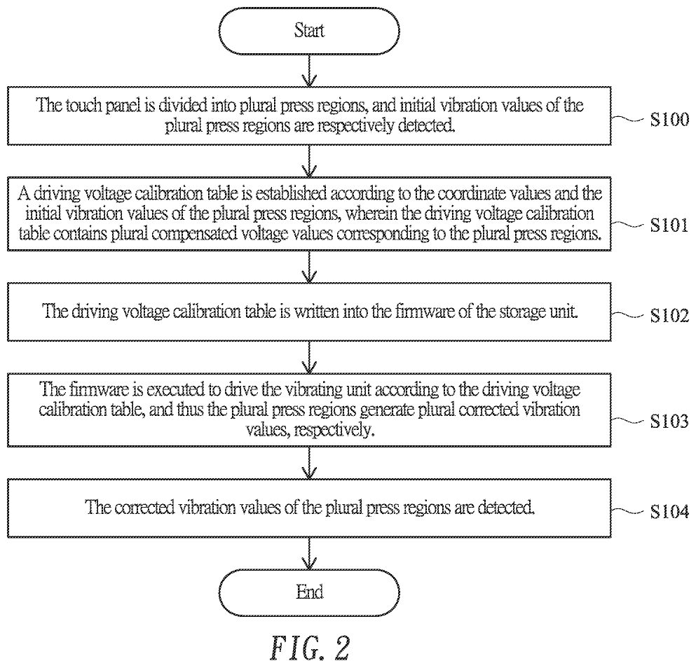

FIG. 2 is a flowchart illustrating a touch feedback correction method according to an embodiment of the present invention.

Firstly, in a step S100, the touch panel 14 is divided into plural press regions 141˜149, and the initial vibration values G1 of the plural press regions 141˜449 are respectively detected. In the step S100, the press regions 141˜149 of the touch panel 14 are arranged in an array (see FIG. 1B).

In case that the touch panel 14 is pressed before the vibration values are corrected, the firmware 111 is executed to provide a standard voltage value Vs to drive the vibrating unit 12 to vibrate the touch panel 14. The G-sensor 80 as shown in FIG. 1A presses on the press regions 141˜449 sequentially and thus detects and retrieves the initial vibration values G1 of the press regions 141˜449.

In an embodiment, the standard voltage value Vs is 4.6V, and the press region 148 is located over the vibrating unit 12. When the standard voltage value Vs is provided to drive the vibrating unit 12, the initial vibration value G1 corresponding to the surface of the press region 148 is used as a standard vibration value Gs. For example, the standard vibration value Gs is 4.4 G. The initial vibration values G1 of the press regions 141˜149 retrieved by the G-sensor 80 are listed in Table 1.

TABLE 1

| | Press region | | | | | | | | |
|---|---|---|---|---|---|---|---|---|---|
| | 141 | 142 | 143 | 144 | 145 | 146 | 147 | 148 | 149 |
| G1 | 3.1 | 3.3 | 3 | 3.7 | 3.6 | 3.4 | 4.6 | 4.4 | 4.6 |

Then, in a step S101, the driving voltage calibration table 92 as shown in FIG. 1A is established according to the coordinate values and the initial vibration values G1 of the press regions 141˜149, wherein the driving voltage calibration table 92 contains compensated voltage values Vc corresponding to the plural press regions 141˜149. In the step S101, the control unit 91 of the computing device 90 acquires the compensated voltage values Vc corresponding to the plural press regions 141˜149 through a calculation process. In the calculation process, the compensated voltage values Vc are obtained according to a mathematic formula: Vc=Vs×(Gs/G1). In the mathematic formula, Vc is the compensated voltage value, Vs is the standard voltage value, Gs is the standard vibration value, and G1 is the initial vibration value. The compensated voltage values Vc corresponding to the plural press regions 141˜149 are listed in Table 2.

TABLE 2

| | Press region | | | | | | | | |
|---|---|---|---|---|---|---|---|---|---|
| | 141 | 142 | 143 | 144 | 145 | 146 | 147 | 148 | 149 |
| Vc | 6.52 | 6.12 | 6.72 | 5.44 | 5.6 | 6 | 4.4 | 4.6 | 4.4 |

Then, in a step S102, the driving voltage calibration table 92 is written into the firmware 111 of the storage unit 11. In the step S102, the driving voltage calibration table 92 established by the control unit 91 of the computing device 90 through the calculation process is written into the firmware 111 of the storage unit 11.

Then, in a step S103, the firmware 111 is executed to drive the vibrating unit 12 according to the driving voltage calibration table 92, and thus the press regions 141˜149 generate corresponding corrected vibration values G2.

Afterwards, in a step S104, the corrected vibration values G2 of the press regions 141˜149 are detected. In the step S104, the G-sensor 80 as shown in FIG. 1A presses on the press regions 141˜449 sequentially and thus detects and retrieves the corrected vibration values G2 of the press regions 141˜149. The corrected vibration values G2 of the press regions 141˜149 retrieved by the G-sensor 80 are listed in Table 3.

TABLE 3

| | Press region | | | | | | | | |
|---|---|---|---|---|---|---|---|---|---|
| | 141 | 142 | 143 | 144 | 145 | 146 | 147 | 148 | 149 |
| G2 | 4.4 | 4.4 | 4.3 | 4.3 | 4.3 | 4.5 | 4.4 | 4.4 | 4.4 |

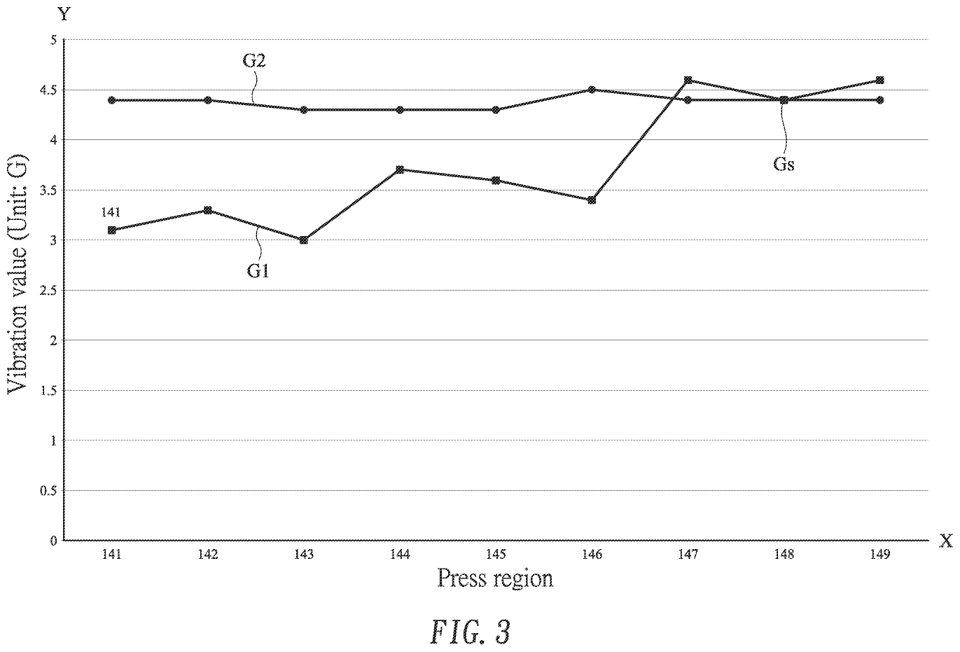

FIG. 3 is a line graph illustrating the vibration values of the press regions of the touch module of the present invention before and after correction. As shown in FIG. 3, the initial vibration values G1 of the press regions 141˜149 are obviously different. After the correction, the corrected vibration values G2 of the press regions 141˜149 are equal or nearly equal.

From the above descriptions, the present invention provides the touch feedback correction method. By the touch feedback correction method, the initial vibration values of the plural press regions on the touch panel of the control module can be corrected. After the correction, the corrected vibration values of the plural press regions on the touch panel are equal or nearly equal. Consequently, the uniformity and consistency of the vibration feels corresponding to different press region will be enhanced. When different press regions of the touch panel are pressed, the touch panel can generate the similar vibration feedback. In other words, the technologies of the present invention are industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

1. A touch feedback correction method for a touch module, the touch module comprising a touch panel, a vibrating unit and a storage unit, the vibrating unit being located under the touch panel to vibrate the touch panel, the storage unit being electrically connected with the vibrating unit, the touch feedback correction method comprising steps of:
(a) dividing the touch panel into plural press regions, and detecting initial vibration values of the plural press regions using a G-sensor when the vibrating unit is driven to vibrate the touch panel;
(b) establishing a driving voltage calibration table according to coordinate values of the plural press regions and the initial vibration values of the plural press regions, wherein the driving voltage calibration table contains plural compensated voltage values corresponding to the plural press regions;
(c) writing the driving voltage calibration table into a firmware of the storage unit; and
(d) executing the firmware to drive the vibrating unit according to the driving voltage calibration table, so that the plural press regions generate plural corrected vibration values, which are equal or nearly equal, respectively.

2. The touch feedback correction method according to claim 1, wherein in the step (a), a specified press region of the plural press regions is located over the vibrating unit, wherein when a standard voltage value is provided to drive the vibrating unit, the initial vibration value corresponding to the specified press region is served as a standard vibration value.

3. The touch feedback correction method according to claim 2, wherein in the step (b), each of the plural compensated voltage values corresponding to the plural press regions is acquired through a calculation process.

4. The touch feedback correction method according to claim 3, wherein in the calculation process, each of the plural compensated voltage values is obtained according to a mathematic formula: Vc=Vs×(Gs/G1), wherein Vc is the compensated voltage value, Vs is the standard voltage value, Gs is the standard vibration value, and G1 is the corresponding initial vibration value.

5. The touch feedback correction method according to claim 1, further comprising a step (e) of detecting the plural corrected vibration values of the plural press regions.

6. The touch feedback correction method according to claim 1, wherein the storage unit is a flash memory, an electrically-erasable programmable read-only memory (EEPROM) or a programmable read-only memory (PROM).

7. A touch module, comprising:
a frame;
a touch panel installed on the frame, wherein the touch panel comprises plural press regions;
a vibrating unit located under the touch panel; and
a storage unit electrically connected with the vibrating unit,
wherein a firmware of the storage unit contains a driving voltage calibration table, and the driving voltage calibration table contains plural compensated voltage values corresponding to the plural press regions, wherein the driving voltage calibration table is established by detecting initial vibration values of the plural press regions using a G-sensor when the vibrating unit is driven to vibrate the touch panel and then acquiring the plural compensated voltage values corresponding to the plural press regions through a calculation process based on the initial vibration values, and the firmware is executed to drive the vibrating unit according to the plural compensated voltage values of the driving voltage calibration table, so that the plural press regions generate plural corrected vibration values, which are equal or nearly equal, respectively.

8. The touch module according to claim 7, wherein in the calculation process, each of the plural compensated voltage values is obtained according to a mathematic formula: Vc=Vs×(Gs/G1), wherein Vc is the compensated voltage value, Vs is a standard voltage value, Gs is a standard vibration value, and G1 is the corresponding initial vibration value.

9. The touch module according to claim 8, wherein when the standard voltage value is provided to drive the vibrating unit, the initial vibration value corresponding to the press region overlying the vibrating unit is served as the standard vibration value.

10. The touch module according to claim 7, wherein the storage unit is a flash memory, an electrically-erasable programmable read-only memory (EEPROM) or a programmable read-only memory (PROM).
